(19) United States
(12) Patent Application Publication
(10) Pub. No.: US 2026/0355547 A1
(43) Pub. Date: Nov. 12, 2026

(54) INTELLIGENT AIR PURIFIER APPARATUS

(71) Applicant: Carmen Schuller, Mooresville, NC (US)

(72) Inventor: Carmen Schuller, Mooresville, NC (US)

(21) Appl. No.: 19/203,898

(22) Filed: May 9, 2025

(51) Int. Cl. A62B 7/10; A62B 7/02; A62B 9/00; A62B 9/02; A62B 18/02; A62B 18/10

(52) U.S. Cl. CPC A62B 7/10; A62B 7/02; A62B 9/003; A62B 9/006; A62B 9/02; A62B 18/02; A62B 18/10

(57) ABSTRACT

The invention relates to a modular, portable, air purifier device capable of supplying filtered or otherwise conditioned airflow to an individual. More specifically, the present invention provides an air purification system that allows for the remote detection and analysis of local ambient air quality and transmit that information to wirelessly connected devices.

### FIELD OF THE INVENTION

The present invention is directed to an air purifier apparatus. More specifically, the present invention is directed to an air purifier apparatus incorporating machine learning or neural networks to implement improved airflow, energy usage, and filtering properties.

### BACKGROUND OF THE INVENTION

Devices for respiratory protection are readily available for medical applications. The most common devices are negative pressure respirators, which typically take the form of either a mask, or a half mask respirator. In either case, the mask covers the nose and mouth while air is drawn through the filter by the negative pressure of inhalation. These types of masks increase respiratory stress because the user must overcome the air restriction presented by the air filter. A tight fit is essential to prevent unfiltered air from entering around the mask instead of through the filter. These types of masks also interfere with normal conversation because they cover both the nose and mouth.

Also available, are Powered Air Purifying Respirators (PAPRs) which use small battery operated motor and fan assemblies to draw air through the filter and supply it at a positive pressure to the user's face mask. These units eliminate respiratory stress and are not dependent on a tight fit between the face and mask. However, they also interfere with normal conversation because they are supplied with full or half masks that cover both the nose and mouth.

The problem with both these types of respirators is that they are not comfortable and are therefore seldom worn outside an industrial workplace. For example, those devices in the prior art, are not portable or unobtrusive enough to be suitable. U.S. Patent to Her-Mou (U.S. Pat. No. 5,267,557) herein incorporated by reference, is directed to providing a nose mask with a filtering device and nose clamp. The mask has been adapted to have an inlet pipe, an exhaust pipe, and the air supply driven by a dc current motor. U.S. Patent to Hauff (U.S. Pat. No. 4,233,972) herein incorporated by reference, teaches providing a battery operated filter blower unit supported by the person. The mask has a filter unit and blower unit that can be adapted to different types of face masks. The filtered blower also has an ejection space for the diffusion of blown air. U.S. Patent to Pokhis (U.S. Pat. No. 4,331,141); Vrabel (U.S. Pat. No. 5,009,225); Sibley (U.S. Pat. No. 5,848,592); Piesinger (U.S. Pat. No. 6,772,762), all of which are herein incorporated by reference, provides a head and upper torso covering devices wherein upon inhalation, air from the ambient surroundings are drawn in through a filter and passed to the user. Additionally, the inventions optionally provide for an electric motor to impel air into the apparatus.

However, there are many non-industrial situations in which respiratory protection would be highly beneficial. Allergy sufferers would greatly benefit from a pollen filter when outside during the allergy season as would people bothered by air pollution on high pollution days. Airline travelers would benefit from a cabin air ozone and germicidal filter, especially on long flights. Hospital workers and patients would benefit from germicidal filters. Finally, industrial workers would benefit from a less obtrusive respirator in non-toxic environments such as woodworking.

Although negative respirators are worn in everyday non-industrial environments, they are seldom worn for long periods of time because of their obtrusiveness, respiratory discomfort, and difficulty in engaging in conversation. Currently available positive pressure PAPRs are large, noisy, and typically are supplied with full face masks. It would be extremely rare to see one of these units worn outside the workplace.

In summary, there are currently no acceptable devices for respiratory protection that are practical and comfortable for use outside the industrial environment.

Figuereo, et al in U.S. Pat. No. 5,878,742, herein incorporated by reference, attempts to make a PAPR more appealing by disclosing a plenum go arrangement near the forehead of the wearer along with a baffle for distributing the air from the plenum downward over the wearer's mouth, nose, and face. However, this device is still very large and obtrusive and would not appeal to users outside the workplace.

The primary problem with current portable PAPRs is that they are powered by fans or blowers. Fans and blowers can only supply very low static air pressures. This requires that large diameter hoses and large surface area air filters be used so as to not overly constrict the airflow from the blower. Typical hose diameters between a belt mounted blower and the facemask are one inch or larger.

Another problem with current negative respirators and PAPRs is that they are designed to cover both the nose and mouth. However, covering only the nose would be perfectly acceptable in many non-toxic environments. For example, an allergy sufferer breathing filtered air through the nose would not be bothered by an occasional breath of unfiltered air through the mouth.

Yet another problem with both negative respirators and PAPRs is that they are only designed to filter the air and not to sterilize or condition it.

Accordingly, it is the object of the present invention to provide a new personal positive pressure powered respiratory protection system having a comfortable and acceptable configuration and a streamlined profile.

Additional technologies, invented by the inventor, are descried U.S. patent application Ser. No. 15/144,540, filed May 2, 2016, U.S. application Ser. No. 15/197,152, filed Jun. 29, 2016 and U.S. application Ser. No. 15/296,725, filed Oct. 18, 2016, all of which are incorporated herein by reference in their entireties.

Furthermore, it is known in the art to use cross-flow membrane filters to filter fluids. However, current use of such cross-flow membrane filters does not include their incorporation into personal air purification techniques.

Therefore, what is needed in the art is an air purification apparatus that is easily configured for different filtering situations by offering various types of membrane air filtration, sterilization, and conditioning capabilities using application specific filter modules.

### SUMMARY OF THE INVENTION

In accordance with the broad aspects of the present invention, the apparatus disclosed provides a portable air purifier capable of supplying filtered or otherwise conditioned airflow to an individual.

In yet another configuration, an air purification system is provided that includes a flexible customized mask configured to form an air-tight seal over at least the eyes, nose and mouth of the wearer. In a particular implementation, the air purification system further includes one or more humidity management devices to reduce or prevent the deposition of moisture on an interior surface of the customized mask.

In one embodiment, the air purification face mask features a full-face design with positive air pressure to ensure a secure fit and effective filtration. Integrated sensors assess exhalation and CO2 levels, while additional sensors measure the pressure for inhalation at the intake. The mask includes a disease mapping collection system that analyzes data and transfers it to the Centers for Disease Control (CDC) in real-time. To prevent fogging, the mask is equipped with a fogging sensor and a moisture threshold sensor. A top vent on the interior blows air at the surface of the see-through mask to clear fogging via an air curtain, which activates for a specified period or until the sensor detects levels below the threshold. Alternatively, a built-in camera facing the interior surface can detect fogging or droplets and activate the air curtain accordingly.

In a further implementation, the mask incorporates anti-fogging materials and maintains a distance of ¼ inch off the face for comfort. It includes a microphone and speaker to facilitate clear speech and is made from pliable material that extends from the hairline to the chin, accommodating bearded individuals with an under-neck design. The mask also features a valve for the removal of exhaled breath, with sensors mounted in the valve to monitor and regulate airflow. These features collectively enhance the mask's functionality, comfort, and effectiveness in various environments.

In yet a further arrangement, one or more processors of the described air purification system are configured to communicate with one or more artificial intelligence systems. Here, the artificial intelligence systems are configured to receive data from one or more sensors integrated within the customized mask and generate one or more recommendation or determinations regarding the presence or likelihood of airborne chemical, radiological, biological, or viral hazards.

In one particular implementation, a portable air purification apparatus is provided comprising an air supply module configured to provide a stream of compressed air; a facial mask; and an air supply conduit, wherein the air supply conduit comprises at least one integrated filter device, the one integrated filter device having a first interface and a second interface, the first interface configured to be selectively coupled to the air supply module and the second interface configured to be selectively coupled to the facial mask.

### BRIEF DESCRIPTION OF THE DRAWINGS

The foregoing and other features of the present invention will be more readily apparent from the following detailed description and drawings of illustrative embodiments of the invention in which list the drawings and their captions.

FIG. 1 is an illustrative diagram of one of the components of an embodiment of the invention.

FIG. 2 is an illustrative diagram of one of the components of an embodiment of the invention.

FIG. 3 is an illustrative diagram of components of an embodiment of the invention.

FIG. 4 is a cross-sectional view of elements of one embodiment of the invention.

FIG. 5 schematic diagram according to one embodiment of the present invention embodiments.

FIG. 6 is an illustrative view of one particular embodiment of the present invention.

FIG. 7 is an illustrative view of a particular embodiment of the present invention.

### DETAILED DESCRIPTION OF THE INVENTION

By way of overview and introduction, the present invention concerns a personal air purifier apparatus designed to filter contaminants from the ambient air and direct a continuous flow of filtered air to the user.

In one or more arrangements, an air purification system comprising: a flexible mask configured to form an air-tight seal over at least the eyes, nose, and mouth of a wearer; at least one humidity management device configured to reduce or prevent the deposition of moisture on an interior surface of the mask; and at least one processor configured to communicate with at least one artificial intelligence system, wherein the at least one artificial intelligence system is configured to: receive data from at least one sensor integrated within the flexible mask; and generate at least one recommendation or determination regarding at least one airborne hazard selected from the group consisting of chemical, radiological, biological, and viral hazards.

In an alternative implementation, a filter of the air purification apparatus uses a cross-flow filter membrane that is portable and discreet. In one or more further implementations, an air purification device is provided that can be worn on the face and includes one or more integrated sensors to detect biometric data from the wearer. The detected biometric data is incorporated, in one or more further implementations, as part of a neural network that controls the opening or closing of input and outlet valves. In yet a further arrangement, an air purification apparatus incorporating one or more sensor devices is provided, where the one or more sensor devices are configured to evaluate the presence of one or more contaminants within the filtered or unfiltered air. For instance, based on measurements of the ambient environment, one or more pre-trained neural networks are configured to generate values that correspond to instructions to activate one or more selectively activable filter devices. By way of example, where the neural network is configured to receive sensor data from one or more temperature, humidity, atmospheric pressure and particulate sensors, the air purifier is configured to activate one or more selectable state activation filters based on an assessment of the neural network. Such conditions can be correlated to one or more adverse atmospheric conditions such that the neural network is able to dynamically respond to changing atmospheric conditions based on such predictions.

In one or more particular implementations, the portable air purifier apparatus includes filter module interchangeability, such that new filters and functionality are provided in one or further implementations. Additionally, the apparatus makes use of one or more filtering elements using a cross flow filtering system. The cross-flow membrane system of the described apparatus is resistant to clogs. Additionally, due to the nature of air flow through the filtering modules, the filter modules have self-cleaning properties through the rejection, rather than absorption, of contaminants. In a further implementation, the air purification apparatus also includes one or more remote pressure monitoring sensors and associated control circuitry. For example, the air purifier apparatus of the present invention includes functionality that alerts the user to when the filtering module has accumulated a pre-determined threshold of concentrated contaminants and needs to be changed.

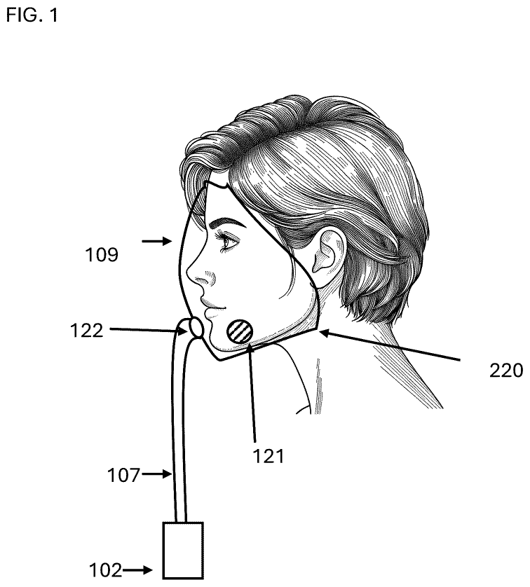

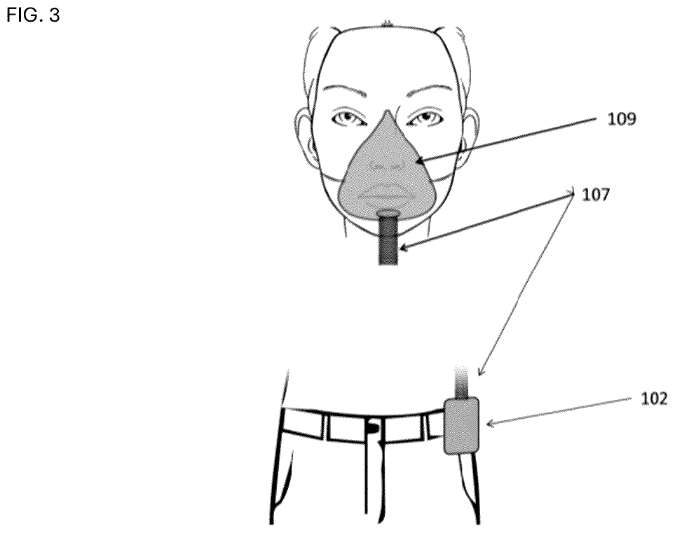

With particular reference to FIGS. 1-3, the apparatus described is a modular, portable, powered air purifier unit capable of supplying filtered or otherwise conditioned airflow to an individual on demand. More specifically, the air purifier apparatus of the present invention includes a mask 109, connectable to an air supply control and source device 102 via an air supply conduit 107. In a particular implementation of the apparatus, the air supply control and source device 102 is worn directly on the body of the user.

### Mask Configuration

In one arrangement, the mask 109 is configured to provide both eye and respiratory orifice protection. For example, as shown in FIG. 1, the described face mask 109 is configured to be placed over the mouth, nose and eyes of the wearer. In this configuration, the wearer is protected from airborne toxins or hazards. In one or more configurations, the face mask 109 is configured to extend from the crown or hairline of the wearer to the under the wearer's chin. In a further arrangement, the mask is configured to extend to cover the ears of the wearer as well. As described in more detail herein, in one or more implementations, the mask 109 is secured to the wearer through the use of straps or fasteners or other securing materials.

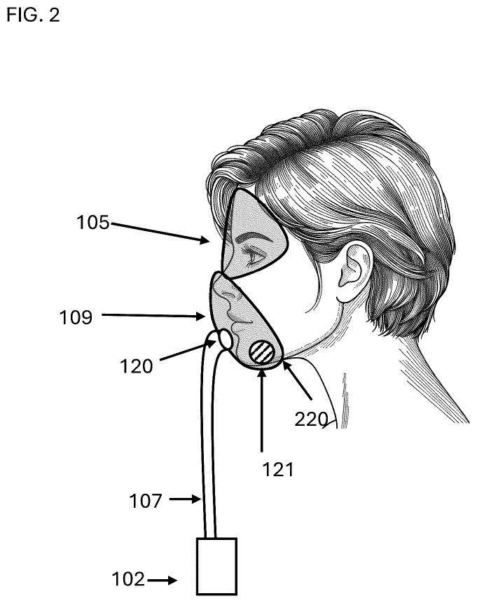

As shown in FIG. 2, the mask 109 can be bifurcated or divided into different zones or areas. In one arrangement, the mask 109 is formed of a single construction piece, with dividers or gaskets that prevent the flow of air from the mouth and nose of the wearer to the eyes of the wearer and vice versa. In an alternative configuration, the eye protection portion of the mask 105 is configured as a removable or detachable module. Here, the removable or detachable module 105 is configured to fit over the eyes of the wearer, and is designed to cover the eyes and provide a clear field of vision. In one or more arrangements, such goggles are contoured so as to form a tight seal with the mask 109. In this configuration, the environment enclosed by the eye protection portion of the mask 105 is not in fluid communication with the environment enclosed by the remaining portions of the mask 109.

In a further arrangement, a coupling or interconnecting mechanism (not shown) configures the eye protection module 105 and the mask module 109 to be securely attached to each other. Such a mechanism includes clips, magnets, or other fastening devices that ensure the modules remain connected during use. The interconnecting mechanism is configured to be easy to use, thereby permitting the modules to be quickly attached or detached as needed.

In one or more arrangements, the eye protection portion of the mask 105 include one or more visual display elements, such as a heads-up display, transparent display, monocle, or other display device that is configured to provide visual information to the user. In one particular configuration, the display is configured to provide visual indications as to the ambient air quality or presence of specific or general contamination levels. For example, the goggles are equipped with one or more processors configured to receive data from the processor integral to the mask 109, or from the sensors integral to the eye protection portion of the mask 105.

It will be appreciated that the described face mask offers multiple avenues of protection for the wearer. For example, the provided face mask arrangement provides comprehensive protection against pathogens that may infect an individual through the nose, mouth or eyes. For example, the described approach allows for separate protection for the eyes and mouth, ensuring that both respiratory and ocular safety are addressed.

Additionally, the described approach provides an eye protection module and mouth protection module that can be used together or separately, providing flexibility for different environments and needs. For example, the wearer is able to remove the portion of the mask that covers the nasal and oral cavities without removing the eye protection.

As shown in FIGS. 1, 2 and 4 the provided design is also configured with a pliable or flexible rim portion 220. For example, the circumference of both mask 109 (and where present the eye protection portion of the mask 105) are configured with one or more deformable layers 402. These deformable layers are able to conform to the specific physiological features of the wearer. For example, the deformable layer is configured to deform over hair follicles, scars, and other changes in texture that typically prevent the formation of an air-tight or near air-tight seal between masks and the face of the wearer. In one or more arrangements, the deformable layer 402 is a rubber, plastic, or other flexible material that compresses when placed in contact with the skin of the wearer.

It will be appreciated that individuals with substantial facial hair often find that masks are ill fitting and leave gaps that allow the introduction of outside or ambient air into the interior of the mask. Here, the deformable layer 402 is pliable and flexible such that when applied to facial hair, the flexible layer compresses and flows around hair so as to form a more air-tight seal.

To achieve a secure yet removable seal between the face mask and the wearer's skin, various adhesive approaches may be employed along the perimeter of the mask 109 (and/or the goggle portion 105). In this manner, the face mask 109 (and/or the goggle portion 105) can be configured to be attached to the wearer without the need of straps or other retention devices.

In one arrangement, the deformable layer 402 includes or incorporates one or more adhesives that removably bond to the wearer.

In one arrangement, the adhesives are medical-grade silicone gel adhesives, such as 3M 2477P, Dow Corning Silpuran 2114, or Scapa Soft-Pro Silicone Gel Adhesives are utilized. It will be appreciated by those possessing an ordinary level of skill in the requisite art that these materials provide a flexible, low-irritation, and reusable interface that conforms to facial contours while maintaining a substantially air-tight and water-resistant seal. Unlike traditional pressure-sensitive adhesives, silicone gel adhesives allow for multiple applications and removals without significant loss of adhesion or damage to the mask or skin.

In an alternative configuration, hydrocolloid adhesives, such as DuoDERM Extra Thin or Tegaderm Hydrocolloid, are used alone, or in combination with any of the previously described approaches. It will be understood and appreciated that hydrocolloid adhesives are utilized to create a soft, cushioned, and moisture-resistant seal. These adhesives find utility in medical dressings and can provide semiocclusive barrier properties while still being removable without residue or skin damage.

In one or more further arrangements, acrylic-based medical adhesive films, such as 3M Tegaderm Transparent Film or Medipore+Pad, are used alone or in combination with any of the previously described adhesives. As used herein, acrylic-based medical adhesives offer strong initial adhesion with moderate breathability and can be applied in pre-cut strips or as a continuous rim around the mask.

In yet a further arrangement, hydrogel-based adhesives, such as TheraBond 3D Hydrogel Strips or MediTac Hydrogel Adhesive Tape, provide a repositionable, skin-friendly, and flexible seal. In this respect, hydrogel-based adhesives are particularly suitable for applications requiring frequent removal and reapplication, such as the mask described herein.

Regardless of the specific chemical or structural formation employed, the rim of the mask described will include a substantially air-tight interface while prioritizing user comfort, reusability, and skin safety, thereby enhancing the overall efficacy and wearability of the face mask system so described.

In one or more implementations, the mask 109 is configured such that there is at least ¼-inch clearance between the face of the user and the interior surface of the mask 109.

In a particular embodiment of the present invention, the described air purification device includes a mask 109 configured to cover the nose and the mouth of the user. In one or more embodiments, the mask 109 is equipped with a gasket or other material suitable for forming an air-tight seal with the face of a user. In a further embodiment, the mask is equipped with a material hood configured to be passed over the user's head and encase the user's head, with the exception of the user's eyes, nose, and mouth in an antibacterial or contaminant resistant covering. For example, a balaclava style covering, designed to expose only a portion of the user's face, is integrated with the mask. In one or more implementations, such a balaclava style covering includes one or more transparent portions that allow the wearer to see through the covering. In yet a further implementation, the balaclava style covering includes an elastic opening that conforms to the neck of the wearer. In one arrangement, the elastic opening provides for an air-tight seal that prevents the intrusion of air into the interior volume of the covering.

In another embodiment, the mask 202 is equipped with a device or mechanism for securing the mask to the user's face. For example, a strap or band is affixed to the mask 202 and fits around the user's head. In yet an alternative arrangement, the mask 202 is fixed to the user's face through surface tension or suction. In one particular implementation, the mask 202 is configured with a plurality of suction devices around the perimeter of the mask that adhere to the face of the user and are designed to secure the mask to the user's face. In a further arrangement, the interior surface of the mask is coated or formed of an antimicrobial or anti-biological agent.

In one or more arrangements, the mask 109 includes a transparent portion. For example, the mask 109 and goggle portion 105 are transparent such that the facial features of the wearer are visible to observers. In one arrangement the mask (either the mask 109 alone, the goggle 105 alone or both) are formed of Thermoplastic Polyurethane (TPU), Polycarbonate (PC), Polyvinyl Chloride (PVC), Silicone, and Polyethylene Terephthalate Glycol (PETG). In particular, TPU has suitable flexibility, durability, and transparency characteristics that make it suitable for medical devices and protective gear. Likewise, PC offers strong impact resistance and clarity which would make it suitable for use in the mask 109 and goggle portion 105. In one or more further arrangements, PVC, depending on its manufacturing process, can be manufactured to be both flexible and transparent and utilized in the mask 109 and goggle portion 105. Likewise, transparent silicone materials and PETG can be molded into semi-rigid shapes suitable for use in the mask 109 and goggle portion 105.

In another configuration, as shown in FIGS. 1 and 2, the mask 109 is a single continuous material that is configured to cover the mouth and nose, providing respiratory protection. In one or more configurations, the mask includes an inlet port 122 to receive purified air from the air supply device 102. In one or more further arrangements, the mask 109 includes one or more outlet ports 122.

In one particular configuration, the outlet ports are configured with baffles or valves that only open upon the exhalation of the wearer. In one or more arrangements, such baffles can only be opened when the air pressure inside the volume enclosed by the mask 109 exceeds the ambient air pressure.

In one particular configuration, the outlet ports can be connected back to the air supply system to provide for a closed loop respiration system. In this arrangement, exhaled air would be passed through one or more filters to remove excess CO2.

### Sensor Integration

In one or more implementations, the mask 109 of the device described is configured with one or more integrated sensors. These sensors are configured to measure the interior environment that is enclosed by the mask 109 as well as the exterior ambient environment and transmit these measurements to one or more processors for further analysis and action.

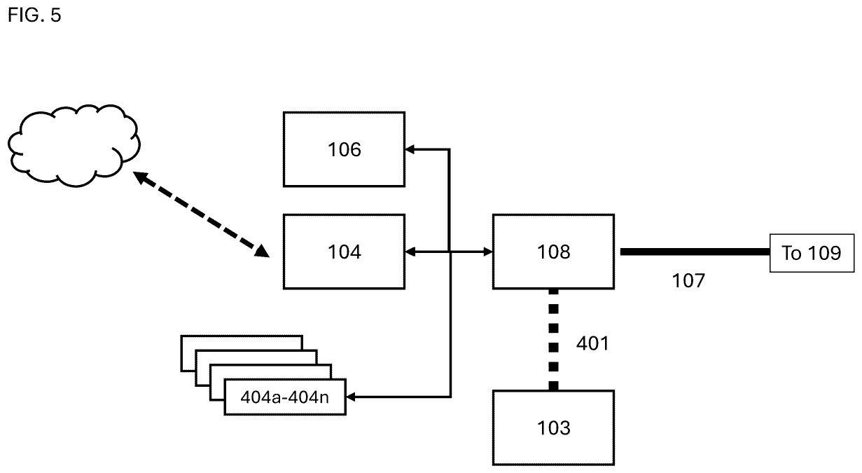

Turning to FIG. 5, the mask 109, in one embodiment, is equipped with one or more sensors (404a-404n) connectable to one or more local or remote computer processors, such as the control unit 104. Here, the processor(s) 104 are configured to receive sensor measurements made by the one or more sensors 404a-404n and make determinations about the presence or absence of compounds or contaminants within the ambient air. In one arrangement, the sensors 404a-404n are configured to sample or analyze ambient air and make an assessment of contaminants or infectious agents present in the ambient air. In one or more non-limiting embodiments, the sensors 404a-404n integral to the mask 109 can include one or more of the following properties, procedures, requisite hardware and software necessary to effectuate: Gas chromatography-mass spectrometry; GC-MS Proton transfer reaction mass spectrometry PTR-MS and PTR-TOF; selected ion flow tube mass spectrometry SIFT-MS; Ion mobility spectrometry (IMS); Fourier transform infrared spectroscopy FTIR; Laser spectrometry spectroscopy; Chemical sensors or Electronic noses. The described sensor may implement one or more of the following: metal-oxide-semiconductor (MOSFET) devices—e.g. a transistor used for amplifying or switching electronic signals. In this arrangement, each additional measured particulate will directly affect the transistor in a unique way, producing a change in the MOSFET signal that can then be interpreted by pattern recognition computer systems, such as ones integrated into the mask of the present device and determine the particular presence of one or more contaminants.

Sensors 404a-404n in alternative embodiments further include organic polymers that conduct electricity; polymer composites or a further combination of non-conducting polymers with the addition of conducting material such as carbon black; a quartz crystal microbalance sensor utilizing the change in frequency of a quartz crystal resonator to sense the presence of compounds within the air and/or surface acoustic wave (SAW) devices that utilize the modulation of surface acoustic waves to sense a physical phenomenon, such as the presence of various compounds.

In another arrangement, the air analyzed by the sensors 404a-404n is sent to one or more processor 104 for evaluation by code executing therein. For instance, based on an analysis of the measurements obtained by the sensors 404a-404n, the processor 104 is configured to determine the presence of specific agents within the ambient air.

Upon such a determination, an alert is issued to the wearer of the mask 109. For example, upon determining a high concentration of pollutants, a processor integral (with associated elements such as memory, input/output, and power) or remote to the mask sends an audio alert to a wearer informing them of the particulate level. Where the processor 104 is integral to the mask 109, in one arrangement the processor is configured to communicate with a wireless communication device (such as a smartphone) and provide an application executing on the wireless communication device with the data gathered by the sensors of the mask. For instance, the one or more processors 104 are configured to receive and evaluate the sensor data transmitting such information to a mobile computing device, such as a connected smart phone or other device. Here, the mobile computing device is configured to display an alert on the display portion of the device (such as a screen on the smartphone, or on the screen of a smartwatch).

In one or more further arrangements, one or more sensors 404a-404n are configured to measure the CO2 or Oxygen content of the exhaled breath of the wearer. For example, sensors like the Senseair S8, a compact and low-power NDIR CO2 sensor module, or the Cubic CM1106SL-N, are both sensor devices that are known in the art. NDIR CO2 sensor modules offer reliable measurements with a compact form factor that is suitable for incorporation into the mask and platform described.

For oxygen detection, the electrochemical or other sensor devices can be used. For example, the AlphaSense O2-A2 electrochemical sensor and Teledyne R-17D galvanic oxygen sensor are used in the art for medical and industrial O2 sensing. Additionally, long-life galvanic cell-type oxygen sensors can be used to determine the O2 component of the mask environment.

In these configurations the relevant sensors 404a-404n are placed within an interior portion of the mask 109. However, in other further arrangements, sensors configured to evaluate the exhaled breath of the wearer can be located at the outlet port 121, or one or more devices connected to the outlet port 121.

In a further arrangement, the mask 109 or a portion thereof is equipped with one or more air pressure sensors. In one or more arrangements, the air pressure sensors are configured to determine the air pressure of the volume of air enclosed by the mask. For example, the air pressure sensor(s) are configured to evaluate the air pressure of the interior volume relative to the ambient air pressure. In one or more arrangements, there are air pressure sensors both on the exterior of the mask and within the interior volume.

In one or more arrangements, where the described sensors 404a-404n are configured to communicate data to one or more processor 104, the processors are configured to evaluate the data obtained and instruct one or more actions in response. For example, where a processor receives data indicating that the air pressure within the enclosed value exceeds the ambient air pressure by a pre-determined threshold, the processor is configured to cause one or more dynamically or controllable valves to actuate. In one arrangement, these valves are integrated or attached to into the mask 109. In another arrangement, such controllable valves are connected to the outlet port 102 of the mask 109. However, in one or more further arrangements such described valves are integrated into an air supply control device 102 connected to the mask via one or more air conduits or tubes 107.

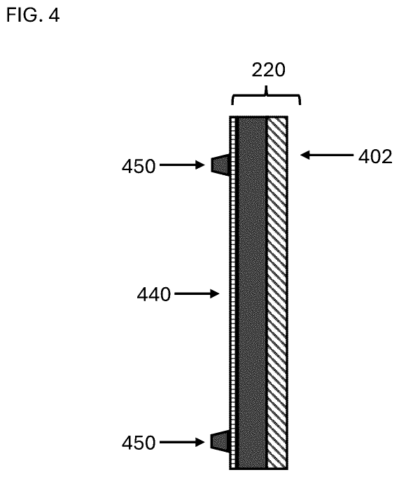

As shown in FIG. 4, in yet a further arrangement, the mask 109 includes one or more directed air nozzles 450. In one arrangement these directed air nozzles 450 are configured to direct air from the air supply control device 102 to the surface of the mask. For example, the directed air nozzles 450 are configured to pass air from the air supply control and source device 102 through the conduit 107. Here, the inlet port 122 includes one or more branches or diverters that permits air flowing into the mask inlet port 122 to be directed through a conduit 440 to the directed air nozzles 450. These nozzles 450 are integrated into the rim (across the surface of the mask so as provide a curtain of air between the max surface and the wearer. In one arrangement, this curtain of air is configured to adjust the humidity of the interior volume enclosed by the mask. For example, where the user's exhalation begins to produce fog or condensation on the interior surface of the mask, a processor 104 is configured to cause the air supply control and source device 102 to direct dehumidified air into the interior volume, thus restoring a proper humidity level.

In a further implementation, one or more optical sensors are used to determine if the transparent portion of the mask has begun to fog or otherwise become occluded. Based on these sensor measurements, the processor 104 is configured to activate the ports and cause conditioned air to be passed over the interior surface of the mask.

In a further arrangement, one or more temperature sensors are also integrated into the exterior and interior portions of the mask 109. Here, these temperature sensors are configured to determine the difference between the interior temperature and the exterior ambient temperature. Where such temperature differential is likely to cause the mask to fog, the processor dynamically causes conditioned air to flow over the surface of the mask. In this manner, fog is prevented from forming, as opposed to remediating it once it has occurred.

In one or more further arrangements, the interior or exterior portions, or both, of the mask 109 and/or goggles 105 are configured with an anti-fog coating. In one or more arrangements, the anti-fog coating is provided with anti-fog sprays, such as those containing ethoxylates, polysiloxanes, and isopropyl alcohol, create a hydrophobic layer that prevents condensation. In an alternative arrangement, the user is able to apply an anti-fogging composition during use by employing anti-fog wipes, which often include water, ethanol, decyl glucoside, sorbitan oleate, vinegar, rubbing alcohol or another composition that can be used to reduce surface tension and prevent fogging.

In one or more further arrangements, one or more sensors 404a-404n users are utilized to determine nuclear, chemical, or biological hazards, such as fallout or biological and chemical weapons. For example, in one or more implementations, the air supply control and source device 102, the mask 109 or the body of the wearer, can integrate a Geiger counter to monitor for ionizing radiation indicative of a nuclear event. Likewise, complementary chemical sensors can also be distributed on the various hardware platforms described, and can include electrochemical gas sensors and semiconductor-based detectors that are sensitive to toxic industrial chemicals and warfare agents such as nerve or blister agents. Additionally, optical sensors using infrared or ultraviolet spectrometry can also be distributed on the various hardware platforms described and used to analyze ambient air for the unique molecular signatures of chemical contaminants. These sensors can be augmented with auxiliary environmental sensors—such as temperature and humidity sensors—to calibrate readings in real time and minimize false positives under varying conditions.

To address the detection of biological threats, the air purification system described can, in one or more particular implementations, incorporate biosensors to determine the presence of biological agents. In one arrangement, such biological sensors include microfluidic and lab-on-a-chip technologies for rapid pathogen identification. Such biosensors can be designed to detect specific proteins, nucleic acids, or other biomarkers that signal the presence of bacterial, viral, or toxin-based biological agents. In some configurations, wearable devices might also include immunosensors that use antibody-antigen interactions to quickly flag harmful agents in the environment.

In one or more arrangements, the mask 109 includes one or more integrated microphone and speakers. For example, the exterior of the mask 109 includes at least one speaker that transmits any sounds uttered by the wearer. Here, one or more microphones are located within the interior of the mask. Sound uttered by the wearer is transmitted from the microphone and to the speaker. However, in one or more arrangements, the sound is first processed by the processor 104. For example, the processor 104 is configured to amplify the sound, isolate or reduce associated noise or otherwise process the sound for improved comprehension when it is relayed through the speakers.

In yet a further arrangement, the mask 109 includes one or more sensors that are configured to evaluate the facial expressions of the wearer. For example, one or more cameras, IR sensors or other devices are integrated into the mask 109, but orientated such that the facial expressions of the wearer can be evaluated for the purposes of determining the state of the wearer. For example, visual data is provided to the processor. In one arrangement, the visual data is provided continuously. However, to conserve batter power, the visual data can be obtained in intervals. For example, once every minute, every five minutes, every 10 minutes and the like.

Alternatively, the optical sensors (such as a camera) are configured to send visual data about the user upon a triggering event. By one non-limiting example, where in the processor 104 receives data indicating that the CO2 level within the enclosed mask environment exceeds preferred levels, the optical sensors can be used to obtain visual data of the face of the wearer. This visual data can be provided to one or more machine learning systems or other data analytics platforms to determine if the wearer is suffering distress or other ill effects. Likewise, even without out the triggering event, such visual data can be transmitted to one or more local or remote machine learning systems to evaluate the status of the wearer.

In a particular arrangement, the pressure sensors are integrated within the controllable outlet valve connected to the outlet port 121. In this configuration, the pressure sensor can measure the pressure on the outlet valve and transmit this information to the processor 104.

Furthermore, the sensors referenced throughout are configured to analyze the expelled air are further configured to provide information to the processor(s) 104, and indicate the presence of contaminates within the expelled air of the user.

In one or more implementations one or more pulse oximeters are integrated into a portion of the mask 109. For example, a pulse oximeter is located in a portion of the rim that is in contact with the forehead of the wearer. Placement here allows for continuous monitoring without the need for finger clips or wristbands.

In one or more arrangements, the sensors located both within and exterior to the air purification device are configured to evaluate the presence of chemicals, microorganisms, radiological or radioactive products or compounds, or other indicators of the health of the wearer. For example, one or more sensors are configured to sense the CO2 or other levels in the environment. Additionally, one or more sensors are configured to identify bacterial, viral or chemical agents, such as viral pathogens.

In one or more implementations, the integrated sensors that assess exhalation, level of pressure for inhalation at the intake, real-time disease presence is stored and used for further reference by the processor. In one or more further arrangements, the real-time data stored by the processor is transferred to one or more remote monitoring or mapping locations. For example, such data is sent to the Centers for Disease Control, or the World Health Organization. In this way, multiple instances of the mask, worn by different persons, can be used to generate a real time map of disease or toxin presence.

In a further implementation, a plurality of masks can communicate with one another to determine or map the contaminants present in a pre-defined geographic location. For example, where a plurality of air purification devices are present in a location, the air purification devices are equipped with packet radio, RF, Wi-Fi, or other low power data transmission capabilities. Once an individual air purification device determines the presence of a contaminant, this data can be broadcast to the other air purification devices. In one implementation, the other air purification devices log this information or selectively activate one or more filtering devices or elements to counteract the presence of the discovered contaminant. Such data sharing can be implemented in real-time, as during a natural disaster where unknown toxins may be released and carried to different locations (such as by wind, etc.).

In another arrangement, the air purification device is configured to communicate with a database, data storage device, or appliance to record and update a central repository with information about the ambient air quality in the location provided by the user. Alternatively, a GPS unit, in one arrangement, is also incorporated air purification device and communicates with one or more processors to provide location data and to transmit location data to a user display or to a remote database. In one particular arrangement, the processor 104 of the air supply and control unit 102 is configured to access a database of present contaminants based on location data. For instance, where a database of atmospheric contaminants is maintained, which includes location data, the processor is configured to implement one or more activable filters based on the database of contaminants. By way of non-limiting example, where the database determines that the present location includes high levels of an atmospheric toxin, the processor is configured to selectively engage or activate a filter element designed to filter such a toxin.

In a further embodiment, the sensors are integral to the filter modules and are designed to communicate via RF frequencies with one or more processors, such as either the remote computing devices, databases, servers, or other air purification devices.

In a particular embodiment, the conduit 107 is configured to provide electrical power to the mask 109 and goggles 105. For example, the conduit includes one or more electrical conduits that connect to the air supply device 102 and its stored battery or power supply. This conduit then interfaces with one or more electrical conduits that are integral to the mask 109.

In one or more arrangements, the processor 104 is also connected to the common power interface and is integral to the air purifier device. In one or more further arrangements, each sensor that is electrically connected to the power supply is able to transmit data using the electrical connections or a common data bus. For example, DC based powerline communication, direct data connections or wireless connections (such as Wi-Fi, Bluetooth, or near field RF communication) can be used to have the sensors 404a-404n connect and exchange data with the processor 104.

In a particular embodiment, the processor 104 is configured to evaluate through the one or more connectable sensors and filter modules if the present ambient environment is toxic or contaminated. When toxins are detected, the processor 104 is configured by one or more software modules to use the signature of each filter to determine if one or more filters is sufficient to purify the ambient air. By way of non-limiting example, where one or more sensors detect a hazard (e.g. airborne toxin), the processor 104 evaluates the toxin against a stored or accessible list (stored locally or accessible on or through a network) of agents that can be filtered by the one or more filters or conditioning modules. Where the present filters are unsuited to filtering the specific toxin, an alert or alarm is raised indicating that the level of protection is inadequate.

In one or more implementations, the processor 104 is configured to provide sensor data from a plurality of sensors, such as O2 and CO2 content of the wearer's exhalation, pulse (using a pulse oximeter), temperature measurements, and other sensors to one or more remote computers. Here, the remote computer evaluates the data using one or more artificial intelligence (AI) models, such as a neural network or a large language model. Based on the artificial intelligence model evaluation of the sensor data, health information is then relayed to the wearer or one or more other remote monitors. By way of non-limiting example, the AI models are trained to evaluate the correlation between pulse, temperature, CO2 and O2 content of exhalations and determine if the wearer is in physiological distress or will likely enter into physiological distress.

### Custom Mask Generation

In one or more configurations, the shape or configuration of the face mask is customized to the individual user. For example, using one or more personal face scanning applications, a user is able to obtain a 3D scan of the intended wearer's face. Using this scan, a 3D-printed face mask, or components thereof, can be generated. By way of non-limiting example, one or more devices configured to employ photogrammetry are used to obtain a 3D scan of an intended wearer's, face, head or portions thereof. Such photogrammetry techniques can be carried out by specialized hardware, or by specific software utilizing sensors (optical Lidar, etc.) integrated into consumer electronic devices. For example, it will be appreciated that certain smartphone and tablet models (such as Appl Computer's iPhone and iPad devices) are configured with such software and sensors.

It will be appreciated that photogrammetry is a technique that involves capturing a series of photographs from different angles and using software to stitch these images together to create a detailed 3D model. This method leverages the principles of optics and geometry to measure and interpret the spatial relationships between objects in the images. To scan an individual's face using photogrammetry, multiple high-resolution photographs of the person's face from various angles would be taken. These images are then processed using photogrammetry software to generate a 3D model of the face. Once the model is created, it can be refined and exported as a file compatible with 3D printing, such as an STL file. Using a 3D printer, it is then possible to print a mask that is customized to fit the individual's face perfectly. This process allows for the creation of masks that are not only personalized in terms of fit but can also be customized in design and material to meet specific needs.

In a particular embodiment, the mask 202 worn by the user is equipped with one or more outlet valves configured to expel air back to the surroundings. In a particular embodiment, the outlet valves are operable by positive or negative pressure valves, such as spring or diaphragm actuated devices such that upon exhalation the valves open and allow air back into the environment. In another arrangement one or more sensors are connected to an electronically activated valve and cause the valve to open in response to measured biometric conditions, such as chest movement or detected exhalation.

### Air Control Device

By way of non-limiting example only, the air supply control and source device 102 is worn by the user on a waistband or by clipping it to a belt loop. In an alternative implementation, the air supply control and source device 102 is worn via a strap, holster, inserted into backpack or other harness device or article secured to the user. In yet a further implementation, all of the elements described herein are integrated into a mask or mask apparatus designed to fit over all or a portion of the user's head.

As shown in FIG. 5, the air supply control and source device 102 includes at least a power supply 106, an airflow generator 108 and a control device 104. For example, the power supply 106 is a battery pack, fuel cell, or wireless charging device. Here, the power supply is one or more rechargeable or non-rechargeable battery cells. Alternatively, the power supply 106 is one or more wireless power devices, such as a collection of solar cells or photovoltaic materials. It should be appreciated that various combinations of power elements are combinable as the power supply 106. For instance, where a solar cell is used, a collection of rechargeable batteries are also employed to provide supplemental power.

In still a further embodiment, AC/DC, 5V, airplane or automobile converters or charger interfaces are provided so that the power supply 106 is configured to access or obtain electrical power from an electrical grid, a transport power plant, or a generator. The power supply 106 provides and distributes power to the airflow generator 108 and to the control device 104.

In one particular implementation, the control device 104 is one or more processors or computers configured to directly or wirelessly connect and control the operations of one or more devices suitable to be controlled thereby. By way of non-limiting example only, a processor of the control device 104 is configured by code executing therein to exchange data with one or more airflow sensors, biological or toxin detection sensors, or environmental sensors, selectable valves, control surfaces, display systems, remote computers, and integrated transmitters. Likewise, the control device 104 is configured to control the operation of the air flow generator 108. As provided in more detail herein, the control device 104 can be any computer, processor, or collection thereof, suitably configured to execute the control operations described herein.

The airflow generator 108 includes electrical, and optionally, data connections to the control device 104 and power supply 106. The airflow generator 108 is configured to extract ambient air from the surrounding environment via one or more air intake vents or ports (not shown) and direct extracted air to the user by way of the air supply conduit 107. In one or more implementations, the airflow generator 108 is an air compressor. Building on this particular example, the air compressor of the described apparatus is designed to function utilizing the low current and voltage supplies of batteries and other direct current power sources. The air compressor may be a custom or commercially available compressor suitable for the functions described herein. It will be appreciated by those possessing an ordinary level of skill in the requisite art that the airflow generator 108 includes all necessary gearing, valves, and other air movement elements necessary for a functioning air compressor so as to be fully described.

The electrical connections that provide linkages to the power module are provided within the body of the housing and are configured to direct electricity towards the internal mechanism of the airflow generator 108. For example, in one or more implementations, the airflow generator 108 is a brushless motor.

In another implementation, the air compression module 103 is configured to use a standard fan-bladed compressor to compress air. Here, the air is extracted through vent openings. For instance, vents integral to the form factor of the airflow generator 108 itself or the larger source device 102 provide inlets for ambient air to enter the system described. In an alternative implementation, the airflow generator 108 uses blade-less fans or air compression devices, such as impellers. In a still further embodiment of the device, the airflow generator 108 implements a bladed intake fan along with induced effects from an impeller using the Coanda effect. For example, the airflow generator 108 is configured to generate low-pressure zones around a vent and induce air flow that lacks buffeting. Therefore, in those embodiments incorporating this type of air compressor, the resulting air stream is less volatile and provides for a gentler inhalation experience. Those skilled in the art would rapidly recognize those materials and housing elements that would suitably allow for the durable construction of an air compressor, such as steel, plastics, composites and synthetic materials.

In a still further embodiment of the air purification device and platform described herein, air supplied to the filtering elements described herein may be supplied by a compressed air source, or air supply 103. In one arrangement, the compressed air source or supply is a stored canister of pressurized air. In another arrangement, the compressed air source is a device, such as an atmosphere pressurization device (compressor) configured to supply compressed air.

For example, the airflow generator 108, in one arrangement provides an inlet port for connection of a compressed air hose or supply line. Here the compressed air hose or supply line 401 is connected to one or more mechanical ventilators or other devices that provide a flow of air to the apparatus described herein. In a particular implementation, an air pressure or air flow sensor (not shown) is used to detect the presence of compressed air being provided to the inlet port. Based on the measurements obtained by the air pressure or air flow sensors, a processor of the control unit 104 causes the air compression module 103 to activate, deactivate, or vary the amount of air supplied to the air purification device. For example, where the processor of the control unit 104 determines, based on measurements made by the air pressure or air flow sensor, that the inlet port is supplying sufficient air to the user, then the processor 104 causes the air compression source 103 to deactivate. However, where the flow provided to the inlet decreases below a pre-determined threshold, the processor of the control unit 104 causes the air compression source 103 to generate sufficient airflow by compressing ambient air to raise the flow of air provided to the user above the pre-determined threshold. For instance, where a separate compressed air supply (such as an air tank) is connected to the air purification device described herein, the air compression module can operate more efficiently by modulating its operation. Once the air supply is disconnected or exhausted, the air compression source 103 then operates to supply the user with the desired air flow.

Turning back to the configurations described herein, the air supply conduit 107 is arranged to receive the compressed air generated by the airflow generator 108. In a particular embodiment, the air supply conduit 107 is a hose or conduit of flexible constructions and is designed to allow the mask 109, the air supply conduit 107, and the source device 102 to each have a relatively high degree of freedom of movement relative to one another. For example, the air conduit 107 is one or more layers of flexible plastic or synthetic material that are air impermeable or semi-impermeable.

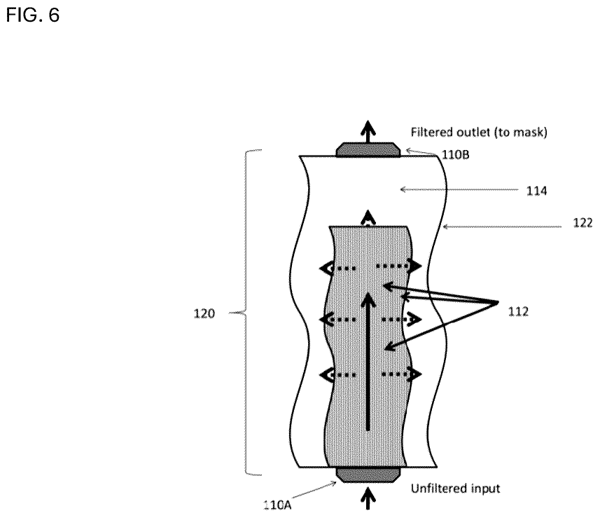

In one particular implementation of the present apparatus, the air supply conduit 107 incorporates one or more filtering devices 120 positioned in line with the conduit or connectable between portions of the conduit 107 and configured to filter the ambient compressed air prior to delivering the air to the mask 109. With particular reference to FIG. 6, the air supply conduit 107 incorporates one or more crossflow filtration membranes.

For ease of discussion, but without limitation to the particular mechanisms of action described herein, crossflow filtration refers to a type of filtration processes where feed flow (such as a fluid in need of filtering) travels tangentially across the surface of the filter, rather than into the filter. One advantage of the crossflow filtering (also known as tangential flow filtration TFF) approach is that the filter cake (e.g. the accumulated particulates on the filter) is substantially cleaned away during the filtration process, increasing the length of time that a filter unit can be operational. Another benefit relative to air purification is that the crossflow filtration in certain implementations is a continuous process. In contrast, typical air purifiers use dead-end filtration in which the feed is passed through a membrane or bed, trapping the solids in the filter and releasing the filtrate at the other end.

Generally, crossflow is used in processes for extracting small particle sized permeate from complex component feed stocks. In crossflow filtration, the feed is passed across the filter membrane (tangentially) at positive pressure relative to the permeate side. A portion of the material, which is smaller than the membrane pore size, passes through the membrane as permeate or filtrate. All other materials, such as toxic compounds or other elements, are retained on the feed side of the membrane as retentate. With crossflow filtration, the tangential motion of the bulk of the fluid across the membrane causes trapped particles on the filter surface to be rubbed off. This means that a crossflow filter can operate continuously at relatively high solids loads without blinding and forms the basis of the described self-cleaning functionality.

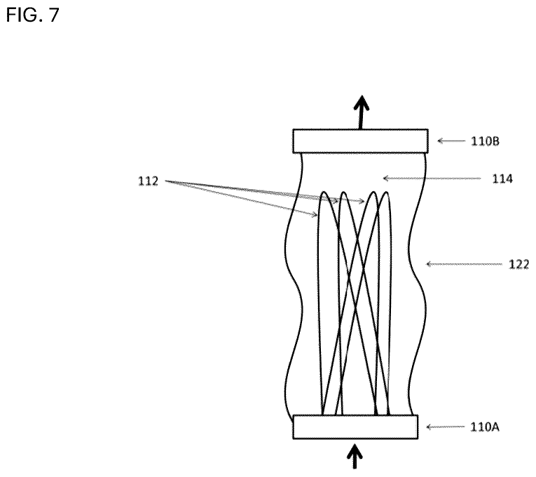

With continued reference to FIGS. 6-7, the air supply conduit 107 contains one or more filter modules 120. In a particular implementation, the filter modules 120 contain one or more filter elements 112. In a particular example, the filter modules 120 have a flexible exterior sheath or encasement 122 that permits a degree of flexibility. In one or more particular implementations, the flexible exterior sheath is impermeable to gas. For example, when the filter modules are connected to one another, a gas impervious conduit is formed such that only air that has entered from the inlet is passed through the filtering elements. In this configuration successive filters can be placed in series so as to allow for successive filtering of a single source of air.

The filter elements 112 are a collection of hollow filter fibers which form a fiber membrane. Each filter fiber 112 is formed of a porous filter material and has a central lumen running its length. In one specific implementation, the filter fiber 112 has a length of between 30 to 110 cm and lumen diameters of 0.5 to 1.75 mm. In one specific implementation, the lumen has a circular cross section. Alternatively, the cross section of the lumen is rectangular, oblong, or oval. While the provided illustration depicts the fibers and roughly cylindrical in shape, it will be appreciated that the filter fibers can assume any shape so long as they possess a central lumen.

The body of the filter fiber is equipped with pores to filter a fluid flow passing tangentially across the interior surface defined by the central lumen. In one particular implementation, the range of pore sizes in a given filter fiber determines the selectivity of the filter. For example, the filter fibers 112 are microfiltration filters with pore sizes of 0.1 μm and larger. In another implementation, the pore size of the filter fibers 112 are within the range of 0.1 to 1 μm, as these pore sizes are suitable for separation of cellular organisms of a certain size. In a further implementation the filter fibers use ultrafiltration pores. Ultrafiltration filter fibers have pore sizes in the range 20 to 100 nm, and are generally characterized in terms of the nominal molecular weight cutoff (NMWC), which is the molecular weight of the largest globular protein that can pass through the membrane. NMWC values range from 1 to 100 kD (kiloDalton). These filters are used for concentrating and fractionating protein streams, virus concentration, desalting, and buffer exchange. The objective of most ultrafiltration processes is to retain airborne macromolecules such as bacteria, spores, toxins, viruses, contaminants and impurities above a certain size, while allowing the air to pass through the filter fibers.

Thus, in one or more implementations, successive filters can be arranged in series with filtering elements. Each filtering element in the series provides increasingly small pore sizes.

In one particular implementation, as shown in FIGS. 6-7 both ends of the filter fibers 112 are connected to an air intake interface 110A incorporated into the filter module 120. The air outflow interface 110B is configured to connect one filter module to another, or to connect the filter module 120 to the mask 109. In a particular implementation, the air intake interface 110A includes one or more flow restriction baffles or conduits that direct all of the compressed air from the air compressor to the lumens of the filter fibers 112. However, in an alternative configuration, the filter fibers 112 are closed at one end such that only one end is connected to the air intake interface 110A.

When a fluid stream (such as compressed air) is passed with positive pressure through the lumen of the fibers, the permeate (filtered air) passes (shown as dashed arrows) through the porous material and exits into the collection area 114. It should be understood that the pressure difference caused by the air compressor drives components that are smaller than the pores through the filter. Furthermore, once passed through the filter, the filtered air is directed out through an air outflow interface 110B and to the mask 109 or to a second or subsequent filter module 120.

In one or more implementations, the interfaces (110A, 110B) include a check valve that opens or closes depending on whether the filter element is connected to the air supply control and source device 102 and/or the mask 109 or another filter module 120. In a particular implementation, the check valves permit the removal of the filter element for inspection of contained or trapped contaminants or for refurbishment.

In an alternative implementation of the filter module 120 as shown in FIG. 4, the filter members 112 are each composed of large hollow fibers. In this arrangement, each fiber is connected at both ends to the air intake interface 110A. According to the provided implementation, the fibers are capable of moving and flexing along with the flexible material sheath 122.

In an alternative configuration, the filter module 120, as shown in FIGS. 6-7, uses a single filtering material 112 having a central lumen. A cross-section of the filtering material 112 is provided in dashed lines. Here, a continuous stream of air (solid arrow) is passed tangentially across the interior surface of the filter element and exits through a venting port 116. In one particular implementation, the air exiting the venting port 116 is recycled and sent via a secondary conduit (not shown) back to the air compressor. Alternatively, in one or more implementations, the air exiting the venting port 116 is vented to the ambient surroundings.

In the provided configuration, particles having a size smaller than the pores of the filtering material 112 are able to pass through the filter material (shown as dashed arrows). The filtered air exits the filtering module through the outflow port 110B. In a particular arrangement, a secondary air conduit (not shown) connects the outflow ports of each filtering module 120 of FIGS. 6-7 and provides the collected air of each filtering module to a purified air conduit (not shown) that is coupled to the mask 109.

In one or more further implementations, each filtering module 120 is formed of flexible construction, thus allowing the series of interconnected or singular filter modules to function as a conduit between the mask and the air compression module 103.

While the modules herein described are an embodiment of the device as depicted in the Figures, those skilled in the art would recognize the additional modules that could be stacked on the device in question. For example, in a non-depicted embodiment, an additional UV filter is added to the filtering stage. A humidifier module can be added in addition or in alternative to the modules already provided. In both these embodiments, one or more electrical connections (such as those described in relation to the module power implementations provided herein) supply power sufficient to enable proper functioning of the modules 120. In an alternative arrangement, such additional functionality is implemented within each of the filter modules. For example, a filter module includes one more UV filtering elements in addition to the physical filtering media.

In a non-depicted embodiment one or more implementations the filter modules 120 are communicatively coupled to one another such that the entire length of the air supply conduit 107 is comprised of filter modules 120. Here, each filter module is equipped with a flexible outer surface encasing one or more filter elements 112. Such configuration permits the air supply conduit 107 to function both as the filtering device as well as the conduit device that delivers filtered air to the mask 109. In one or more implementations, the filtering modules 120 include different filter materials. For example, the total length of the air supply conduit 107 can comprise filter modules 120, each having progressively smaller pore sizes. Alternatively, in one or more implementations, each filter module 120 comprising the air supply conduit 107 is utilized to filter a particular particulate or atmospheric agent. Here, one or more airborne pathogens, toxins, agents, or particulates are filtered by a specific filter, such that an additive effect of such filtering is provided.

In a further arrangement one or more of the filter modules incorporates sensors or other devices to permit the measurement of conditions, such as internal pressure, number and nature of airborne contaminants. In one or more implementations, the filter modules are configurable with one or more electrical or electronic components as provided herein.

In a further arrangement, biometric sensors, used to measure biometric conditions, are integrated into a wearable measurement platform, such as a smartwatch. In one arrangement, one or more pre-trained neural networks are used to control the opening and closing of the outlet valves. For example, an artificial neural network is trained on the breathing rate and air pressure of a user during normal operation. The neural network can be trained, based on a training data set of normal and abnormal breathing as well as exhalation patterns correlated to biometric data. For example, shallow breathing may be correlated to one or more biometric measurements, such as blood pressure, blood oxygen levels, or pulse. Based on the biometric measurements obtained by one or more biometric measurement devices, the neural network outputs a signal determining the amount of time that the outlet valves should be opened. For example, where the artificial neural network determines that the user is taking shallow breaths, the valves will open for short durations. In circumstances where the valves open in response to internal pressure, the pressure generated by shallow breathing may be insufficient to trigger the valve operation. Thus, the neural network controls the opening of the valves to ensure that the exhaled air is vented from the mask 209.

In one or more embodiments, the air purifier device described is configured to generate a positive pressure within the mask so as to prevent the infiltration of biological, chemical or radiological elements into the interior space of the mask 202.

The outlet valve in one or more configurations directs the expelled air to a filtering attachment 203. In a particular configuration, the filtering attachment is directly affixed to the mask 109. The filtering attachment includes one or more filtering elements (not shown). One filtering element is a HEPA filter designed to filter out microorganisms from the air expelled by the user. In a further arrangement, the filtering elements are connectable or stackable such that air that passes through a first filter is then passed through a second filter, and subsequent filters. In one arrangement, a filtering element is a UV filter element, or other radiation delivering filter that is designed to deliver radiation to the air that has been expelled by the user.

Furthermore, prior to exiting to the ambient air, the expelled air (including air that has been filtered) is analyzed by one or more sensors arranged to analyze the air expelled.

The outlet vent is, in one arrangement, connected to the expelled air filters via a conduit or hose. In this configuration the wearer can pipe or direct the expelled air to a series of filters that are affixed to the wearer or are otherwise remote to the wearer.

The filter module can be selectively engageable, that is the filtering functions themselves can be selectively engaged by a user manually, or via a pre-programmed routine stored within the memory of a computer. For example, ionizing radiation inserts integral to a filter module are selectively engaged for specific events or situations. Other inserts for the filter modules are envisioned.

In a further embodiment of the air purification apparatus described, an oxygen generation module is provided. The air or oxygenation module provides a source of clean air or oxygen to the user independent of filters or other mechanisms used to purify air. For example, in instances where the ambient air cannot be filtered, or the filters currently equipped with the air filter apparatus are not sufficient to purify the air to an acceptable level, the oxygenation module provides a source of purified air for use by the wearer. In one configuration, the oxygenation module is a container of pressurized oxygen or air that is equipped with one or more control valves that selectively permit or restrict the flow of air to the air compressor module.

For example, in an arrangement where one or more sensors detect the presence of an airborne toxin that the engaged filters are incapable of filtering, the processor 104 causes the one or more control valves to operate and provide stored oxygen to the user. In one or more further arrangements, the one or more sensors are configured to detect the level of oxygen in the ambient environment. In this arrangement, the air compression module is also configured with a selectively engageable inlet. Thus, the mask becomes an environment where air or oxygen is provided from only a stored source and the exhaled air is permitted to exit the mask due to positive pressure. Alternatively, the stored oxygen can be used to supplement the ambient environment. In such a configuration, the oxygen content of the ambient environment is below a pre-determined threshold. Upon detecting that the oxygen level of the ambient environment has decreased below this threshold, the stored oxygen is mixed with the ambient environment air provided to the wearer. For example, one or more processors are configured to release sufficient stored oxygen to cause the oxygen level in the air provided to the user is above a pre-determined threshold.

It should be understood that various combinations, alternatives, and modifications of the present invention could be devised by those skilled in the art. The present invention is intended to embrace all such alternatives, modifications, and variances that fall within the scope of the subject matter described herein.

In a non-limiting example, the processor of the control unit 104 and any remote computer communicatively coupled to the processor are commercially available or custom built computers equipped with one or more processors, graphical processing units, field programmable gate arrays, RAM and ROM memory, network interface adaptors, and one or more input or output devices. In a further embodiment, the processor 130 or computer 100 is a computer server or collection of computer servers, each server configured to store, access, process, distribute, or transmit data between one another and other computers or devices accessible or connectable therewith. In still a further embodiment, processor 130 (or computer element 100) is a hosted server, virtual machine, or other collection of software modules or programs that are interrelated and hosted in a remote accessible storage device (e.g. cloud storage and hosting implementation) that allows for dynamically allocated additional processors, hardware, or other resources on an “as-needed” or elastic need basis. In a further embodiment, the processor is configured to implement elastic load balancing algorithms to harness remote computing capacity or functionality to enable the system to handle computationally or otherwise resource intensive actions and procedures.

In a particular arrangement, the processor or computers referenced herein are desktop or workstation computers using commercially available operating system, e.g. Windows®, OSX®, UNIX, or Linux based implementation. In a further configuration, the processor or computer is a portable computing device such as an Apple iPad/iPhone® or Android® device or other commercially available mobile electronic device configured to have access to or implement remote hardware as necessary to carry out the functions described. In other embodiments, the processor or computer includes custom or non-standard hardware configurations. For instance, the processor comprises one or more micro-computer(s) operating alone or in concert within a collection of such devices, network(s), or array of other micro-computing elements, computer-on-chip(s), prototyping devices, “hobby” computing elements, home entertainment consoles, and/or other hardware.

Typical types of air filtration that will be provided are particulate, odor, ozone, and selected organic and chemical vapors. Sterilization will be provided using ultra-violet germicidal lamps. Typical air conditioning provided will be heating, cooling, or moisturizing the filtered air.

The portable air purification apparatus of any of the preceding implementations, further comprising one or more sensor devices configured to sample the internal air pressure within one or more filtering modules.

The portable air purification apparatus of any of the preceding implementations, wherein each module is configured with a check valve selectively engageable when the filter is disengaged from the mask or air supply conduit.

While the invention has been particularly shown and described with reference to a preferred embodiment thereof, it will be understood by those skilled in the art that various changes in form and details may be made therein without departing from the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter of the present invention have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Publications and references to known registered marks representing various systems are cited throughout this application, the disclosures of which are incorporated herein by reference. Citation of the above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

The above descriptions of embodiments of the present invention are not intended to be exhaustive or to limit the systems and methods described to the precise form disclosed. While specific embodiments of, and examples for, the apparatus are described herein for illustrative purposes, various equivalent modifications are possible within the scope of other articles and methods, as those skilled in the relevant art will recognize. The teachings of articles and methods provided herein can be applied to other devices and arrangements, not only for the apparatus and methods described above.

The elements and acts of the various embodiments described above can be combined to provide further embodiments. These and other changes can be made to the apparatus and methods in light of the above detailed description.

What is claimed is:

1. An environmental protection apparatus, the apparatus comprising,
a) a nasal cavity portion configured to enclose a volume of air around the nasal cavity of a wearer;
b) an ocular cavity portion configured to enclose a volume of air around the ocular cavity of the wearer;
c) at least one filter device configured to provide a stream of filtered air to at least the volume of air enclosed by the nasal cavity;
d) at least one selectively activatable outlet valve configured to permit air to exit from the nasal cavity portion; and
e) at least one processor configured to control the activation of the selectively activatable outlet valve.

2. The environmental protection apparatus of claim 1, wherein the nasal cavity portion has an interface portion that is configured to be in contact with the face of the wearer, wherein the interface portion includes at least a deformable layer configured to match the topology of the face of the wearer.

3. The environmental protection apparatus of claim 2, wherein the interface portion forms an air-tight seal with the face of the wearer such that external air can not infiltrate into the volume enclosed by the nasal cavity.

4. The environmental protection apparatus of claim 1, wherein the nasal cavity encloses the oral cavity of the wearer.

5. The environmental protection apparatus of claim 1, further comprising an air supply module.

6. The environmental protection apparatus of claim 2, wherein the air supply module is configured to deliver a compressed stream of air to the at least one filter device.

7. The environmental protection apparatus of claim 1, further comprising one or more sensors configured to monitor the air quality external to the volume enclosed by the nasal cavity portion.

8. The environmental protection apparatus of claim 7, wherein data obtained by the one or more sensors is used to provide real-time feedback to one or more report monitoring devices.

9. The environmental protection apparatus of claim 1, wherein the nasal cavity portion includes at least one integrated sensor configured to measure a parameter of the environment enclosed by the mask.

10. The environmental protection apparatus of claim 1, wherein the nasal cavity portion includes one or more directed air nozzles configured to direct air onto an interior surface of the mask to adjust humidity or prevent fogging.

11. An air purification system comprising:
a flexible mask configured to form an air-tight seal over at least the eyes, nose, and mouth of a wearer;
at least one humidity management device configured to reduce or prevent the deposition of moisture on an interior surface of the mask; and
at least one processor configured to communicate with at least one artificial intelligence system, wherein the at least one artificial intelligence system is configured to:
receive data from at least one sensor integrated within the flexible mask; and
generate at least one recommendation or determination regarding at least one airborne hazard.

12. The air purification system of claim 11, wherein the airborne hazards are selected from one of the group consisting of chemical, radiological, biological, and viral hazards.

13. The air purification system of claim 11, further comprising at least one filter device configured to provide a stream of positive pressure filtered air to at least the volume of air enclosed by the flexible mask, and at least one air supply device configured to provide a stream of air to the filter device, wherein each of the filter device and air supply device are controllable by the at least one processor.

14. The air purification system of claim 13, wherein the at least one processor is configured to provide real-time sensor data to the at least one artificial intelligence system; and based on the output of the at least one artificial intelligence system, adjust the operation of the at least one air supply device and the at least one air filter device in response to the presence of the at least one airborne hazard.

15. The air purification system of claim 11, wherein the flexible mask is formed of a transparent material selected from the group consisting of Thermoplastic Polyurethane (TPU), Polycarbonate (PC), Polyvinyl Chloride (PVC), Silicone, and Polyethylene Terephthalate Glycol (PETG).

16. The air purification system of claim 11, wherein the flexible mask comprises a pliable or flexible rim portion configured to deform and conform to the wearer's facial features to form the air-tight seal.

17. The air purification system of claim 11, wherein the at least one humidity management device comprises one or more directed air nozzles configured to direct a stream of air across the interior surface of the mask.

18. The air purification system of claim 11, wherein the at least one humidity management device comprises an anti-fog coating applied to the interior surface of the mask.

19. The air purification system of claim 11, wherein the at least one sensor integrated within the flexible mask is configured to perform gas chromatography-mass spectrometry (GC-MS) to detect the at least one airborne hazard.

20. The air purification system of claim 11, wherein the at least one artificial intelligence system is further configured to generate an alert to the wearer upon determining the presence of the at least one airborne hazard above a predetermined threshold.
